(19) United States
(12) Patent Application Publication
(10) Pub. No.: US 2010/0070627 A1
(43) Pub. Date: Mar. 18, 2010

(54) MONITORING APPARATUS, MONITORING METHOD, AND STORAGE MEDIUM

(75) Inventors: Hideaki MIYAZAKI, Kawasaki (JP); Yuji Nomura, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/561,486

(22) Filed: Sep. 17, 2009

(30) Foreign Application Priority Data
Sep. 18, 2008 (JP) 2008-239803

(51) Int. Cl. G06F 15/173

(52) U.S. Cl. 709/224

(57) ABSTRACT

A monitoring apparatus which monitors an operating state of a monitored apparatus, the monitoring apparatus includes a signal acquiring unit that acquires signals output from the monitored apparatus; a communication amount acquiring unit that acquires a communication amount by which the monitored apparatus performs communication in a specific time based on information included in the plurality of signals that the signal acquiring unit acquires at a specific time interval; and a state determining unit that determines the operating state of the monitored apparatus based on the communication amount acquired by the communication amount acquiring unit.

### CROSS-REFERENCE TO RELATED APPLICATIONS

This application is based upon and claims the benefit of priority of the prior Japanese Patent Application No. 2008-239803, filed on Sep. 18, 2008, the entire contents of which are incorporated herein by reference.

### FIELD

The present invention relates to a monitoring apparatus that monitors an operating state of a monitored apparatus, a monitoring method, and a recording medium that stores a computer program used to cause a computer to perform as the monitoring apparatus.

### BACKGROUND

In recent years, with the development of IT (Information Technology) and the spread of the communication infrastructure, network apparatuses, such as a server, a personal computer, and a workstation, which can be connected to a network, have increased. Further, with an increase in network apparatuses, there has been a rapid increase in the amount of power consumed by the network apparatuses which results in affecting global warming. For this reason, countermeasures that can reduce power consumed by the network apparatuses have been actively studied all over the world.

One of the countermeasures that reduce power consumed by the network apparatuses is to turn off an apparatus that is not being used at the present time. For example, in a data center that manages a plurality of servers, although the servers are not being used, the servers may be supplied with power. Further, in a company or a business place, although a personal computer or a workstation is not used during night, the personal computer or the workstation may be supplied with power. As such, when apparatuses are not being used, supply of power to each of the apparatuses is stopped, thereby reducing power consumption. In order to use this method to reduce power consumption, it is needed to develop an apparatus and a method that can detect a non-used apparatus even though power is supplied to the non-used apparatus.

Examples of a method that detects an operating state of each apparatus that is connected to a network may include a method using MIB (Management Information Base) information that is managed in each apparatus. The MIB information includes a variety of information that is needed when each apparatus uses the network, and an operating state of each apparatus can be detected based on the MIB information of each apparatus.

Further, as another example of the method that detects the operating state of each apparatus, there is a method that uses an application, such as a service quality coordinator (Systemwalker Service Quality Coordinator), in order to manage a server manufactured by Fujitsu Ltd, for example. According to this method, a terminal monitoring agent is set for each apparatus by installing the application in each apparatus. The terminal monitoring agent manages a variety of information that indicates an operating state of each apparatus, and the operating state of each apparatus can be detected based on the information that is managed by the terminal monitoring agent of each apparatus.

However, in the above-described methods, a setting process to monitor an operating state needs to be executed for each apparatus whose operating state needs to be monitored (hereinafter, simply referred to as monitored apparatus). For example, when the MIB information is used, a setting process in order to record the MIB information needs to be executed with respect to each monitored apparatus. Further, when the terminal monitoring agent is used, the terminal monitoring agent needs to be set for each monitored apparatus. Accordingly, as in a server center or a business place, in a situation where a plurality of monitored apparatuses exist or a situation where monitored apparatuses are frequently added, it is difficult to monitor all of the monitored apparatuses surely.

Accordingly, in order to solve this problem, for example, Japanese Patent Application Laid-open (JP-A) No. 2002-16599 proposes a technology for providing a monitoring apparatus to monitor an operating state of each apparatus on a network where each apparatus is connected and analyzing traffic transmitted and received through the network by the monitoring apparatus, thereby detecting the operating state of each apparatus.

Further, Japanese Patent No. 3088636 proposes a technology for transmitting a measurement packet, such as a Ping (Packet Internet Groper), to each apparatus and detecting whether each apparatus operates based on existence or non-existence of a response packet with respect to the measurement packet.

However, according to the technology that is disclosed in JP-A No. 2002-16599, the monitoring apparatus needs to be provided on all of the networks where the monitored apparatuses are connected. That is, in a situation where a plurality of monitored apparatuses are spread throughout a plurality of networks and are connected, since the monitoring apparatus needs to be provided on each network, operation is difficult. Further, when there is no traffic from the monitored apparatus, it is difficult to determine whether a current state is a state where supply of power to the monitored apparatus is stopped or a state where the monitored apparatus is supplied with power but is not being used.

Meanwhile, according to the technology that is disclosed in Japanese Patent No. 3088636, since only one monitoring apparatus may be provided, the configuration can be simplified. In this case, when the monitored apparatus returns a response packet with respect to the measurement packet, it can be determined that the monitored apparatus is supplied with power. Meanwhile, when the response packet is not returned, it can be determined that supply of power to the monitored apparatus is stopped. However, according to the technology that is disclosed in Japanese Patent No. 3088636, it is difficult to detect whether the monitored apparatus, which is determined to be a state where power is supplied, is actually being used by a user.

In this embodiment, it can be determined whether a monitored apparatus is supplied with power and it can be determined whether the monitored apparatus that is supplied with power is actually being used.

### SUMMARY

According to an aspect of the embodiment, a monitoring apparatus monitors an operating state of a monitored apparatus, and the monitoring apparatus includes a signal acquiring unit that acquires signals output from the monitored apparatus; a communication amount acquiring unit that acquires a communication amount by which the monitored apparatus performs communication in a specific time based on information included in the plurality of signals that the signal acquiring unit acquires at a specific time interval; and a state determining unit that determines the operating state of the monitored apparatus based on the communication amount acquired by the communication amount acquiring unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 illustrates the configuration of a monitoring system according to a first embodiment;

FIG. 2 illustrates the configuration of a monitoring apparatus according to the first embodiment;

FIGS. 3A and 3B illustrate storage contents of a monitored address DB and a response packet history DB;

FIGS. 4A and 4B illustrate storage contents of an analysis result DB and a setting information DB;

FIG. 5 illustrates the functional configuration of a monitoring apparatus according to the first embodiment;

FIGS. 6A and 6B illustrate a process of determining existence or non-existence of regular communication by a state determining unit;

FIGS. 7A and 7B illustrate a difference in the traffic amount that is calculated when measurement packets are transmitted at a different transmission interval;

FIG. 8 is a flowchart of a monitoring process according to the first embodiment;

FIG. 9 is a flowchart of a monitoring process according to the first embodiment;

FIG. 10 illustrates the configuration of a monitoring system according to a second embodiment;

FIG. 11 illustrates the functional configuration of a monitoring apparatus according to the second embodiment;

FIG. 12 is a flowchart of a monitoring process according to the second embodiment;

FIG. 13 is a flowchart of a monitoring process according to the second embodiment;

FIG. 14 is a flowchart of a monitored apparatus confirming process according to a third embodiment; and

FIG. 15 is a flowchart of a monitored apparatus confirming process according to the third embodiment.

### DESCRIPTION OF EMBODIMENTS

### First Embodiment

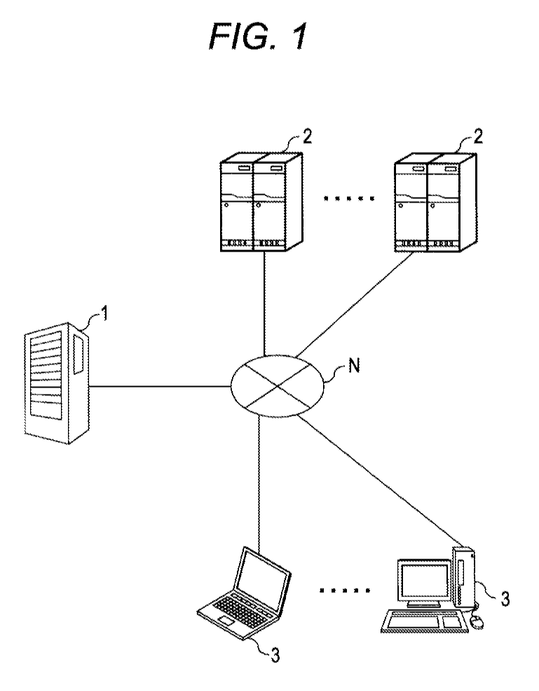

FIG. 1 illustrates the configuration of a monitoring system according to a first embodiment. The monitoring system according to this embodiment includes a monitoring apparatus 1, a plurality of server apparatuses 2, and a plurality of terminal apparatuses 3, which communicate with each other through a network N, such as the Internet.

The server apparatuses 2 are servers, such as a web server, a mail server, and a file server. The server apparatuses 2 provide a variety of data through the network N in accordance with requests from the terminal apparatuses 3. The terminal apparatuses 3 are terminals, such as a personal computer and a workstation. The terminal apparatuses 3 request the server apparatuses 2 to transmit a variety of data, and receive the provided data in accordance with the requests. Between the server apparatuses 2 and the terminal apparatus 3, data (packet) is transmitted and received through the network N.

The monitoring apparatus 1 sets the server apparatuses 2 as monitored apparatuses and monitors operating states of the server apparatuses 2. Specifically, the monitoring apparatus 1 determines whether each of the server apparatuses 2 is in an operating state where power is supplied (hereinafter, referred to as a “power-on state”), or a non-operating state where power is not supplied (hereinafter, referred to as a “power-off state”). Further, when it is determined that each of the server apparatuses 2 is in the power-on state, the monitoring apparatus 1 determines whether each of the server apparatuses 2 is being used.

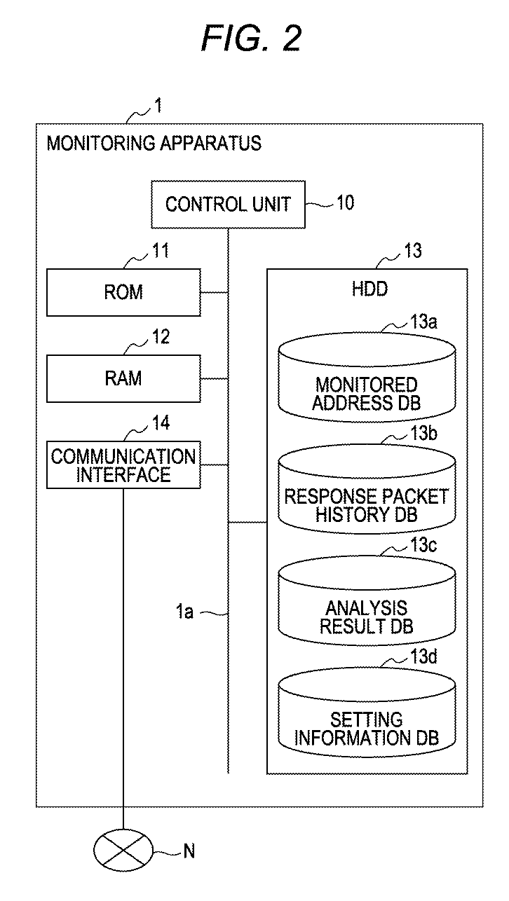

FIG. 2 illustrates the configuration of a monitoring apparatus 1 according to a first embodiment. For example, the monitoring apparatus 1 is a computer, such as a server computer and a personal computer. The monitoring apparatus 1 allows a computer program disclosed in this embodiment to be read out by the computer and the computer program to be executed by a CPU, or the like, of the computer, thereby realizing the monitoring apparatus disclosed in this invention. Further, the monitoring apparatus that is disclosed in this invention may be realized by hardware performing an equivalent function.

The monitoring apparatus 1 includes the control unit 10, a ROM (Read Only Memory) 11, a RAM (Random Access Memory) 12, a hard disk drive (hereinafter, referred to as HDD) 13, a communication interface 14, and the like. The individual hardware units of the monitoring apparatus 1 are connected to each other through a bus 1a.

The control unit 10 is, for example, a CPU (Central Processing Unit) or an MPU (Micro Processor Unit). The control unit 10 includes a clock that clocks an absolute time (a year, a month, a date, a minute, and a second). The control unit 10 reads out a control program, which is previously stored in the ROM 11 or the HDD 13, by the RAM 12 in accordance with specific timing based on a time indicated by the clock, and executes the control program. Further, the control unit 10 controls the operation of the above individual hardware units.

The ROM 11 previously stores various control programs that are needed to operate the monitoring apparatus 1 as the monitoring apparatus disclosed in this embodiment. The RAM 12 is, for example, an SRAM or a flash memory. The RAM 12 temporarily stores a variety of data which is generated when the control program is executed by the control unit 10.

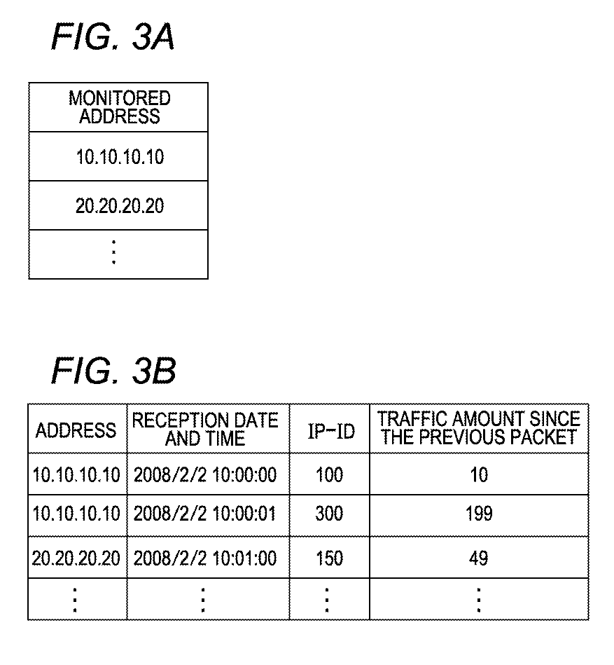

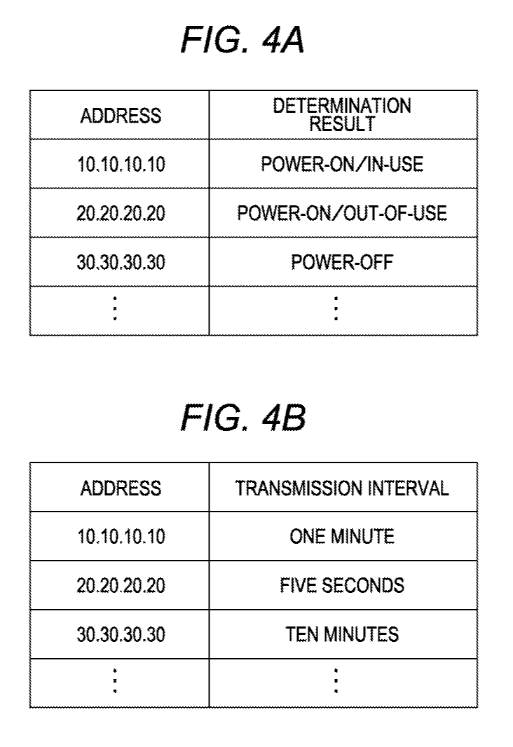

The HDD 13 is a storage device that has a large capacity. The HDD 13 previously stores various control programs that are needed to operate the monitoring apparatus 1 as the monitoring apparatus disclosed in this embodiment. The HDD 13 stores a monitored address database (hereinafter, referred to as a “monitored address DB”) 13a illustrated in FIG. 3A, a response packet history database (hereinafter, referred to as a “response packet history DB”) 13b illustrated in FIG. 3B, an analysis result database (hereinafter, referred to as an “analysis result DB”) 13c illustrated in FIG. 4A, and a setting information database (hereinafter, referred to as a “setting information DB”) 13d illustrated in FIG. 4B.

Further, when the monitoring apparatus 1 includes a driver (not illustrated) that can read out data stored in an external memory (not illustrated), as a variety of information of the monitored address DB 13a and the setting information DB 13d, the variety of information that is stored in the external memory may be read out by the driver and stored in the HDD 13. Further, the variety of information may be downloaded from the external device through the network N and stored in the HDD 13.

The communication interface 14 is an interface that is used to connect various components to the network N. The communication interface 14 performs communication between the server apparatuses 2 and the terminal apparatuses 3 through the network N.

FIGS. 3A and 3B illustrate storage contents of the monitored address DB 13a and the response packet history DB 13b. In FIG. 3A, in the monitored address DB 13a, IP (Internet Protocol) addresses of the server apparatuses 2 that are monitored by the monitoring apparatus 1 are stored. When the monitored server apparatus 2 is added or deleted, the storage contents of the monitored address DB 13a are updated by the control unit 10 whenever a manager who manages the monitoring system adds or changes the storage contents. The storage contents of the monitored address DB 13a are added or changed through an operation unit (not illustrated) of the monitoring apparatus 1 or an external apparatus that can communicate with the monitoring apparatus 1.

The response packet history DB (history information storage unit) 13b stores history information of a response packet that each of the server apparatuses 2 has transmitted with respect to a measurement packet that the monitoring apparatus 1 has transmitted to each of the server apparatuses 2. In FIG. 3B, the response packet history DB 13b stores history information that includes an IP address, a reception date and time, and an IP-ID of each of the server apparatuses 2 to be a transmission source of the response packet and the amount of traffic since the previous packet.

The reception date and time is a date and time when each response packet is received by the monitoring apparatus 1. Instead of the reception date and time, a transmission date and time of the response packet that is included in the response packet may be used. The IP-ID that is information included in each response packet is order information indicating transmission order in which each of the server apparatuses has transmitted each packet. Further, in the monitoring system according to the first embodiment, when each of the server apparatuses 2 transmits each packet, each of the server apparatuses increments a value of an ID field (IP-ID) of an IP header that is included in each packet by one. Accordingly, the transmission order of each packet may be recognized based on the value of the IP-ID.

When response packets are received from a server apparatus 2 that has the same IP address, the amount of traffic since the previous packet indicates the difference between an IP-ID value of the previously received response packet and an IP-ID value of the currently received response packet. In FIG. 3B, history information of the two response packets from an IP address “10.10.10.10” are included, an IP-ID of the subsequently received response packet is 300, and an IP-ID of the previously received response packet is 100. In this case, the “amount of traffic since the previous packet” in the subsequently received response packet becomes 199 obtained by 300-100-1.

Since the value of the IP-ID is incremented by one when each of the server apparatuses 2 transmits each packet, the number of packets that are transmitted while each of the server apparatuses 2 transmits the two response packets may be recognized based on a difference between the IP-ID values in the two response packets. In the monitoring system according to this embodiment, the number of packets is used as the amount of traffic since the previous packet.

The storage contents of the response packet history DB 13b are added by the control unit 10 whenever the monitoring apparatus 1 receives the response packet from each of the server apparatuses 2. When the response packet is received, the control unit 10 stores information of the IP address and the IP-ID, which are included in the received response packet, in the address column and the IP-ID column of the response packet history DB 13b, respectively. The control unit 10 stores a date and time, which is clocked by the clock when the monitoring apparatus 1 receives the response packet, in the reception date and time column. When the monitoring apparatus 1 receives the response packet, the response packet from the same IP address is previously received, the control unit 10 calculates the amount of traffic since the previous packet based on the IP-ID of the previously received response packet and the IP-ID of the currently received response packet, and stores the amount of traffic in the amount of traffic since the previous packet column in the response packet history DB 13b.

FIGS. 4A and 4B illustrate storage contents of an analysis result DB and a setting information DB. In the analysis result DB 13c, the IP addresses of the server apparatuses 2 of FIG. 4A and the determination results are stored in a state where they are associated with each other. The storage contents of the analysis result DB 13c are stored by the control unit 10 whenever the control unit 10 determines an operating state of each of the monitored server apparatuses 2.

In the setting information DB 13d, the IP addresses of the server apparatuses 2 of FIG. 4A and the transmission intervals are stored in a state where they are associated with each other. The storage contents of the setting information DB 13d are previously stored, and are changed by the control unit 10 based on the operating state of each of the server apparatuses 2 determined by the control unit 10.

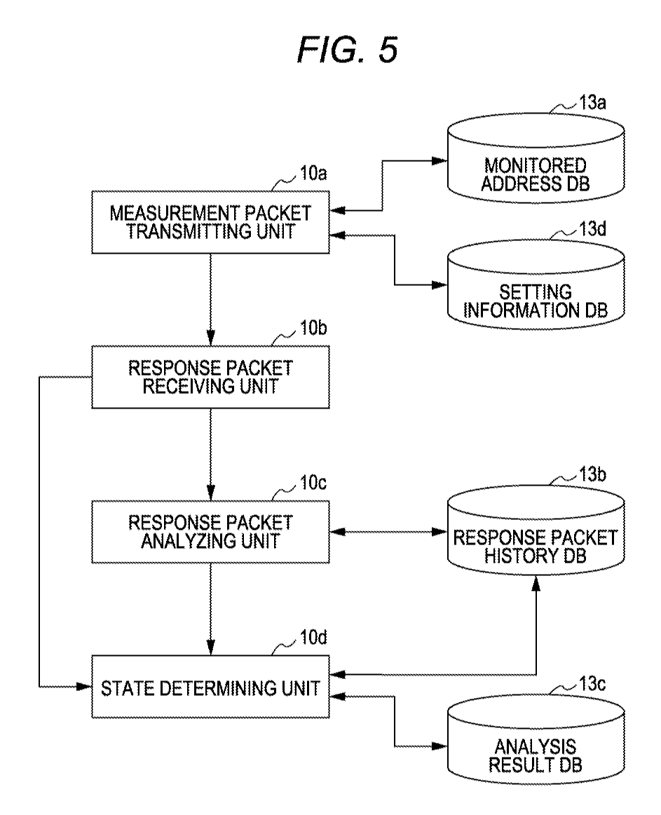

Hereinafter, in the monitoring apparatus 1, the control unit 10 reads out the control program, which is stored in the ROM 11 or the HDD 13, in the RAM 12 and executes the control program, thereby realizing the functions of the monitoring apparatus 1, which will be described in detail below. FIG. 5 illustrates the functional configuration of the monitoring apparatus 1 according to a first embodiment.

In the monitoring apparatus 1, the control unit 10 executes the control program that is stored in the ROM 11 or the HDD 13, thereby realizing individual functions of a measurement packet transmitting unit 10a, a response packet receiving unit 10b, a response packet analyzing unit 10c, and a state determining unit 10d.

The measurement packet transmitting unit (signal output unit) 10a regularly transmits a measurement packet, such as an Echo Request signal of an ICMP (Internet Control Message Protocol), to the monitored server apparatuses 2 based on the storage contents of the monitored address DB 13a and the setting information DB 13d. The measurement packet transmitting unit 10a reads out the IP address that is stored in the monitored address DB 13a and the transmission interval that is associated with the IP address and stored in the setting information DB 13d.

The measurement packet transmitting unit 10a waits timing when the measurement packet is transmitted to each of the server apparatuses 2 having each IP address based on the transmission interval that is associated with each IP address. When the measurement packet transmitting unit 10a detects timing when the measurement packet is transmitted to any one of the server apparatuses 2, the measurement packet transmitting unit 10a transmits the measurement packet to the server apparatus 2.

When each of the server apparatuses 2 receives a specific measurement packet, each of the server apparatuses 2 returns a corresponding response packet. For example, when each of the server apparatuses 2 receives the Echo Request signal of the ICMP, each of the server apparatuses 2 transmits the Echo Reply signal of the ICMP as a response packet to the monitoring apparatus 1. Further, in addition to the ICMP packet, an HTTP (HyperText Transfer Protocol) packet, and an SMTP (Simple Mail Transfer Protocol) packet may be used.

The response packet receiving unit (signal acquiring unit) 10b receives a response packet that is transmitted from each of the server apparatuses 2. When the measurement packet transmitting unit 10a transmits the measurement packet to the server apparatus 2, the measurement packet transmitting unit 10a notifies the response packet receiving unit 10b of an IP address of the server apparatus 2 that has transmitted the measurement packet. The response packet receiving unit 10b determines whether a response packet is received from the server apparatus 2 having the IP address indicated by the measurement packet transmitting unit 10a.

When the response packet from the server apparatus 2 having the IP address indicated by the measurement packet transmitting unit 10a is not received in a specific time-out period after the notification from the measurement packet transmitting unit 10a, the response packet receiving unit 10b notifies the state determining unit 10d of a message indicating that the response packet is not received and the IP address. Further, even when an error packet (ICMP Destination Unreachable signal) indicating that the measurement packet transmitted by the measurement packet transmitting unit 10a is not transmitted to the server apparatus 2 is received in the specific time-out period, the response packet receiving unit 10b sends the state determining unit 10d a message indicating that the error packet is received and the IP address.

When the response packet from the server apparatus 2 having the IP address indicated by the measurement packet transmitting unit 10a is received in a specific time-out period after the notification from the measurement packet transmitting unit 10a, the response packet receiving unit 10b transmits the received response packet to the response packet analyzing unit 10c.

When the response packet analyzing unit 10c acquires the response packet from the response packet receiving unit 10b, the response packet analyzing unit 10c analyzes the response packet, and extracts, from the response packet, an IP address and an IP-ID (ID field of an IP header) of the server apparatus 2 that sent the packet. The response packet analyzing unit 10c associates the extracted IP address and IP-ID and a date and time (reception date and time) when the response packet is received and stores the association result as history information in the response packet history DB 13b.

In addition, the response packet analyzing unit 10c determines whether history information including the same IP address as the IP address of the history information stored in the response packet history DB 13b is previously stored in the response packet history DB 13b. When the history information including the same IP address is not yet stored in the response packet history DB 13b, this means that the response packet is received from the server apparatus 2 having the corresponding IP address for the first time. Accordingly, in this case, the response packet analyzing unit 10c does not execute a calculating process of the amount of traffic since the previous packet of the history information stored in the response packet history DB 13b, and stores no information in the column of the amount of traffic since the previous packet of the history information.

Meanwhile, when it is determined that the history information including the same IP address is previously stored in the response packet history DB 13b, the response packet analyzing unit 10c determines whether a difference between a reception date and time of the history information, which is now stored in the response packet history DB 13b, and a previous reception date and time of the history information including the same IP address is the same as the transmission interval that is associated with the IP address stored in the setting information DB 13d. That is, the response packet analyzing unit (determining unit) 10c determines whether the two response packets are received at the transmission interval set with respect to the IP address.

When the difference between the reception dates and times is not the same as the specific transmission interval, the response packet that the response packet receiving unit 10b has received is set as the first response packet of the monitoring process with respect to the server apparatus 2 having the IP address. Accordingly, in this case, the response packet analyzing unit 10c does not execute a calculating process of the amount of traffic since the previous packet of the history information stored in the response packet history DB 13b, and stores no information in the column of the amount of traffic since the previous packet of the history information.

Meanwhile, when the difference between the reception dates and times is the same as the specific transmission interval, the response packet analyzing unit (communication amount acquiring unit) 10c calculates a difference (communication amount) between the IP-ID of the history information, which is stored in the response packet history DB 13b, and the IP-ID of the history information including the same IP address. The response packet analyzing unit 10c stores the calculated difference as the amount of traffic since the previous packet of the history information that is stored in the response packet history DB 13b.

When the IP address of the server apparatus 2 that does not receive the response packet in the specific time-out period is indicated by the response packet receiving unit 10b, or when the IP address of the server apparatus 2 that receives the error packet is indicated, the state determining unit 10d determines that the server apparatus 2 is in a non-operating state (power-off state). At this time, the state determining unit 10d associates the IP address of the server apparatus 2 and the determination result (power-off) with each other and stores the association result in the analysis result DB 13c.

Further, the state determining unit 10d determines an operating state of each of the server apparatuses 2 based on the history information that is stored in the response packet history DB 13b. The state determining unit 10d determines that the server apparatus 2 is in an operating state but is not used, when the amount of traffic since the previous packet, which is included in the history information, is smaller than the specified value (for example, 10). At this time, the state determining unit 10d associates the IP address of the server apparatus 2 and the determination result “power-on/out-of-use” with each other and stores the association result in the analysis result DB 13c.

Further, when the amount of traffic since the previous packet, which is included in the history information, is the specified value (for example, 10) or more, the state determining unit 10d determines whether the amount of traffic is the amount of traffic based on the specific packet that is regularly transmitted.

Each of the server apparatuses 2 regularly performs communication, such as communication by a routing protocol to confirm a communication path and communication to execute various backup processes. The server apparatuses 2 that perform only the regular communication are assumed as being not used from the terminal apparatuses 3. Accordingly, the state determining unit 10d determines whether the amount of traffic is the amount of traffic based on the regular communication when the amount of traffic since the previous packet that is included in the history information is the specified value or more.

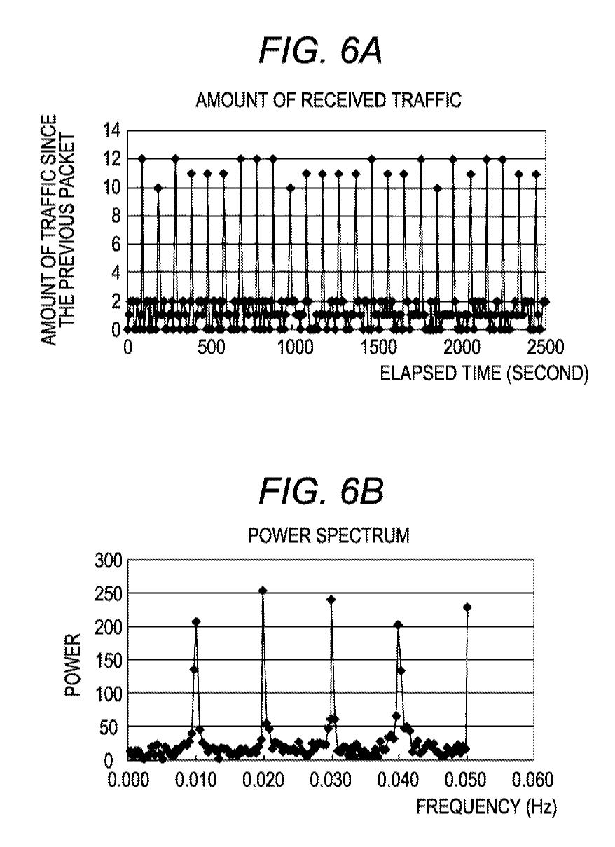

When the amount of traffic since the previous packet that is included in the history information is the specified value or more, the state determining unit 10d uses a Fourier analysis to analyze whether a periodicity exists in the history of the amount of traffic up to this point. FIGS. 6A and 6B illustrate processes of determining the existence or non-existence of regular communication by the state determining unit 10d. FIG. 6A is a graph illustrating the amount of traffic until now in which a horizontal axis indicates an elapsed time and a vertical axis indicates the amount of traffic since the previous packet at each date and time.

When a Fourier transform is performed on the amount of traffic in time series in FIG. 6A, a power spectrum in FIG. 6B is obtained. FIG. 6B illustrates a power spectrum in which a horizontal axis indicates a frequency and a vertical axis indicates power at each frequency. Since the power spectrum in FIG. 6B illustrates the case where communication is generated with a period of 100 seconds (0.01 Hz), it is determined that a periodicity exists in the history of the amount of traffic. Accordingly, it can be seen that the amount of traffic in FIG. 6A is the amount of traffic by regular communication generated for every 100 seconds.

As such, when a periodicity exists in the history of the amount of traffic until now, it is determined that only the regular communication is performed. Therefore, it may be determined that the server apparatus 2, which has the history of the amount of traffic, is in an operating state, but is not actually being used.

Specifically, the state determining unit 10d extracts history information of the same IP address as the IP address where the amount of traffic since the previous packet, which is included in the history information, is the specified value or more, from the response packet history DB 13b. The state determining unit 10d calculates the amount of traffic (refer to FIG. 6A) in time series indicated by the amount of traffic since the previous packet and a reception date and time of the history information extracted from the response packet history DB 13b. Further, the state determining unit 10d performs a Fourier transform with respect to the amount of traffic in time series and calculates a power spectrum (refer to FIG. 6B).

The state determining unit 10d determines whether a periodic peak exists in the calculated power spectrum. When the periodic peak exists in the calculated power spectrum, the state determining unit 10d determines that the server apparatus 2 is in an operating state but is not being used. At this time, the state determining unit 10d associates the IP address of the server apparatus 2 and the determination result “power-on/out-of-use” and stores the association result in the analysis result DB 13c. Thereby, the server apparatuses 2 that perform only the regular communication but are not actually being used may be determined as “out-of-use”.

Further, when a periodic peak does not exist in the calculated power spectrum, the state determining unit 10d determines that the server apparatus 2 is in an operating state and is being used. At this time, the state determining unit 10d associates the IP address of the server apparatus 2 and the determination result “power-on/in-use” and stores the association result in the analysis result DB 13c. Thereby, the server apparatuses 2 that are actually being used can be properly determined as “in-use”.

The state determining unit 10d sets a transmission interval at which the measurement packet is transmitted to each of the server apparatuses 2, based on the analysis result that is stored in the analysis result DB 13c, and stores the set transmission interval in the setting information DB 13d. For example, the state determining unit 10d sets the transmission interval of the server apparatuses 2 that are determined as a power-off state or a power-on/out-of-use state to 10 minutes, and changes the transmission interval stored in the setting information DB 13d to 10 minutes, with respect to the IP addresses of the server apparatuses 2. Thereby, unnecessary measurement packets may be prevented from being transmitted to the server apparatuses 2 in a power-off state or a power-on/out-of-use state, and a load with respect to the network N may be reduced.

Further, the state determining unit 10d determines whether the “amount of traffic since the previous packet” of latest five items of history information stored in the response packet history DB 13b is less than the specific value (for example, 10), with respect to the server apparatuses 2 that are determined as a power-on/in-use state. When it is determined that the “amount of traffic since the previous packet” of the five items of history information is less than the specific value, the state determining unit 10d sets the transmission interval to 10 seconds, and changes the transmission interval stored in the setting information DB 13d to 10 seconds, with respect to the IP addresses of the server apparatuses 2. Further, when it is determined that the “amount of traffic since the previous packet” of the five items of history information is less than the specific value, the state determining unit 10d sets the transmission interval to 1 minute, and changes the transmission interval stored in the setting information DB 13d to 1 minute, with respect to the IP addresses of the server apparatuses 2.

As such, when only an amount of traffic of a constant amount which is less than the specific value is observed based on the five items of history information, the transmission interval of the measurement packet is shortened to shorten an observation time. Thereby, it is possible to determine whether a periodicity exists in the amount of traffic in accordance with the amount of traffic based on the response packet received at a short transmission interval.

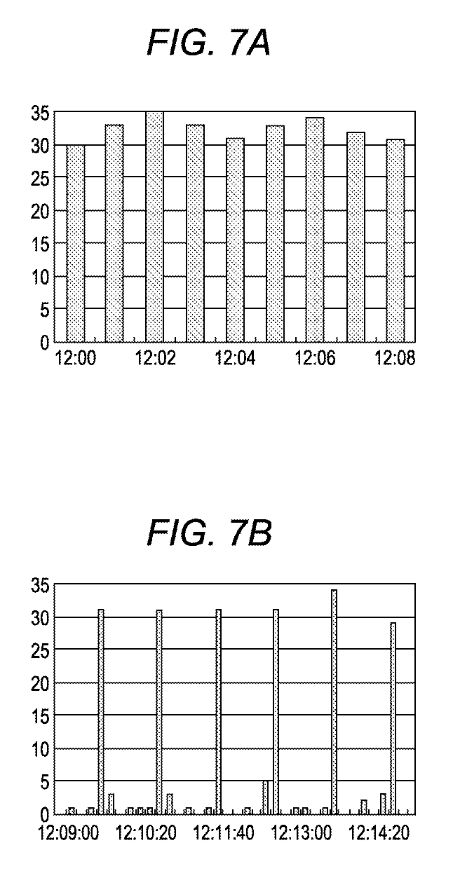

FIGS. 7A and 7B illustrate a difference in the traffic amounts that is calculated when measurement packets are transmitted at a different transmission interval. FIG. 7A illustrates a history of the amount of traffic calculated based on a received response packet when a measurement packet is transmitted in a state where a transmission interval is set to 1 minute. In FIG. 7A, the horizontal axis indicates a date and time and the vertical axis indicates the amount of traffic since the previous packet that is calculated based on a response packet received at each date and time. FIG. 7B illustrates a history of the amount of traffic calculated based on a received response packet when a measurement packet is transmitted in a state where a transmission interval is set to 10 seconds. In FIG. 7B, the horizontal axis indicates a date and time and the vertical axis indicates the amount of traffic since the previous packet that is calculated based on a response packet received at each date and time.

As may be seen from FIGS. 7A and 7B, when a transmission interval of the measurement packet is long (case of FIG. 7A), since the calculated amount of traffic is always constant, it is difficult to determine whether a periodicity exists. However, if the transmission interval of the measurement packet is shortened (case of FIG. 7B), a time-series variation in the calculated amount of traffic becomes apparent. As a result, it is possible to determine whether a periodicity exists in the history of the calculated amount of traffic using a Fourier analysis.

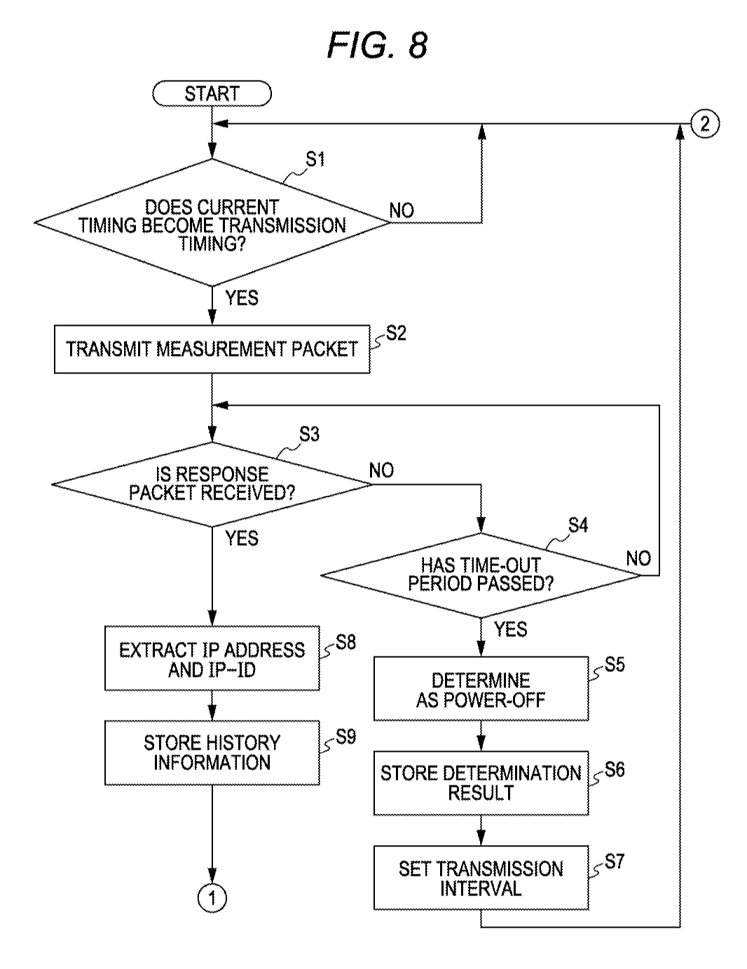

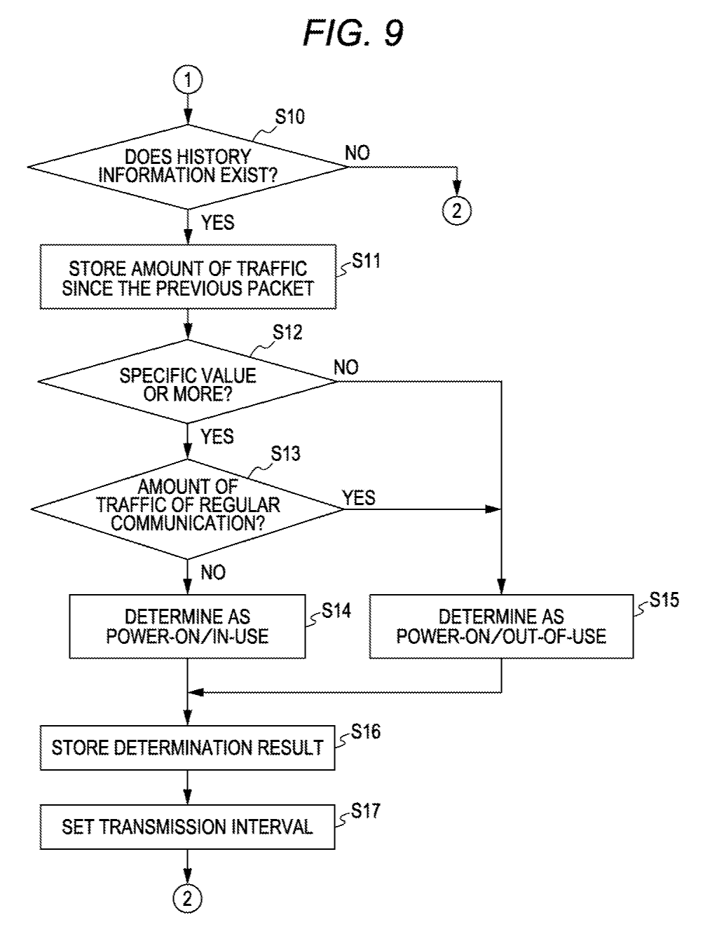

FIGS. 8 and 9 are flowcharts illustrating a monitoring process according to a first embodiment. The following process is executed by the control unit 10 in accordance with the control program that is stored in the ROM 11 or the HDD 13 of the monitoring apparatus 1.

The control unit 10 of the monitoring apparatus 1 waits transmission timing when a measurement packet is transmitted to any one of the server apparatuses 2 based on the storage contents of the monitored address DB 13a and the setting information DB 13d (S1). When the control unit 10 doesn't detect transmission timing with respect to any server apparatus 2 (S1: NO), it maintains a waiting state. Meanwhile, when the control unit 10 detects transmission timing with respect to any server apparatus 2 (S1: YES), it transmits the measurement packet to the corresponding server apparatus 2 (S2).

The control unit 10 determines whether a response packet is received from the server apparatus 2 that has transmitted the measurement packet (S3). When it is determined that the response packet is not received (S3: NO), the control unit 10 determines whether a specific time-out period passes (S4). When it is determined that the specific time-out period has not passed (S4: NO), the control unit 10 returns to Step S3. When it is determined that the time-out period has passed (S4: YES), the control unit 10 determines that the server apparatus 2, which has transmitted the measurement packet in Step S2, is in a power-off state (S5).

The control unit 10 stores the determination result in the analysis result DB 13c (S6). The control unit 10 determines a transmission interval of a following measurement packet based on the determination result, sets the transmission interval in the setting information DB 13d (S7), and returns to Step S1. Further, even when an error packet is received before the time-out period has passed, the control unit 10 executes processes of Steps S5 to S7.

When it is determined that the response packet is received (S3: YES), the control unit 10 extracts an IP address and an IP-ID of the server apparatus 2 of a transmission source from the response packet (S8). The control unit 10 associates the extracted IP address and IP-ID and a date and time indicated by the clock at a corresponding point of time with each other and stores the association result as history information in the response packet history DB 13b (S9).

From the reception date and time of the history information that includes the same IP address as the IP address of the history information stored in the response packet history DB 13b and is stored in the response packet history DB 13b, the control unit 10 determines whether there is history information that includes a reception date and time of a date and time that goes back to the past by the transmission interval corresponding to the IP address (S10). When it is determined that such history information does not exist (S10: NO), the control unit 10 returns to Step S1.

Meanwhile, when it is determined that such history information exists (S10: YES), the control unit 10 calculates a difference between the IP-ID of such history information and the IP-ID of the history information stored in the response packet history DB 13b in Step S9, and stores the difference as the amount of traffic since the previous packet in the history information stored in the response packet history DB 13b in Step S9 in the response packet history DB 13b (S11).

The control unit 10 determines whether the amount of traffic stored in Step S11 is the specified value or more (S12). When it is determined that the amount of traffic is the specified value or more (S12: YES), the control unit 10 determines whether the amount of traffic in the history information of the response packet received from the server apparatus 2 is the amount of traffic based on the regular communication (S13).

When it is determined that the amount of traffic is not the amount of the traffic based on the regular communication (S13: NO), the control unit 10 determines that the server apparatus 2, which has transmitted the measurement packet in Step S2, is in a power-on/in-use state (S14). The control unit 10 stores the determination result in the analysis result DB 13c (S16), determines a transmission interval of a measurement packet to follow based on the determination result, sets the transmission interval in the setting information DB 13d (S17), and returns to Step S1.

When it is determined that the amount of traffic is smaller than the specified value (S12: NO) or is the amount of traffic based on the regular communication (S13: YES), the control unit 10 determines that the server apparatus 2, which has transmitted the measurement packet in Step S2, is in a power-on/out-of-use state (S15). The control unit 10 stores the determination result in the analysis result DB 13c (S16). The control unit 10 determines a transmission interval of a measurement packet to follow based on the determination result, sets the transmission interval in the setting information DB 13d (S17), and returns to Step S1.

The monitoring apparatus 1 according to the first embodiment executes the above-described process with respect to each of the server apparatuses 2 whose addresses are stored in the monitored address DB 13a, thereby determining whether each of the server apparatuses 2 is in a power-off state, a power-on/out-of-use state, or a power-on/in-use state. As such, a state of each of the server apparatuses 2 is determined by discriminating between a power-on state and a power-off state and discriminating between a in-use state and a out-of-use state in the power-on state, thereby grasping whether each of the server apparatuses 2 is actually being used. Accordingly, it is possible to detect the server apparatuses 2 that are not actually being used regardless of supply of power. Further, it is possible to reduce wasteful power consumption by stopping supply of power to the appropriate server apparatuses 2.

As such, since a usage situation of each of the server apparatuses 2 may be grasped, a manager of the monitoring system may grasp the unnecessary server apparatuses 2 and consolidate the server apparatuses 2 whose usage frequency is small. Accordingly, power consumption may be effectively reduced by changing the system configuration.

The monitoring apparatus 1 according to the first embodiment sets the server apparatuses 2 having the addresses that are registered in the monitored address DB 13a as monitored address, and transmits measurement packets at the transmission interval that is registered in the setting information DB 13d. When the measurement packets are transmitted to the server apparatuses 2 having the addresses that are registered in the monitored address DB 13a, when a response packet is not returned or when an error packet is returned, the monitoring apparatus 1 may exclude the server apparatuses 2 from the monitored address.

Further, as a monitored address range, addresses 10.10.10.1 to 10.10.10.254 and 20.20.20.1 to 20.20.20.254 are previously registered. For example, at a specific time of the day, the measurement packets are transmitted to all of the server apparatuses 2 whose addresses are included in the monitored address range. In addition, only the server apparatuses 2 whose response packet is returned may be set as the monitored address, the IP addresses of the server apparatuses 2 may be registered in the monitored address DB 13a, and the corresponding server apparatuses 2 may be set as the monitored address of the following monitoring process.

In this case, even in an environment where the IP addresses of the server apparatuses 2 are dynamically changed like a LAN using a DHCP (Dynamic Host Configuration Protocol), the IP addresses of the server apparatuses 2 that are in a power-on state may be detected and the server apparatuses 2 may be set as the monitored address.

In addition to the configuration of the monitoring apparatus 1 according to the first embodiment, a packet indicating a power supply stop instruction may be transmitted to the server apparatuses 2 that are determined as a power-on/out-of-use state and the supply of power may be stopped. In this case, at a point of time when the server apparatus 2 in the power-on/out-of-use state is detected, the supply of power to the server apparatus 2 may be automatically stopped, and the amount of power that is consumed by the server apparatus 2 may be reduced.

### Second Embodiment

Since a monitoring system according to a second embodiment may be realized by the same configuration as the monitoring system according to the first embodiment, the same constituent elements will be denoted by the same reference numerals and the description will not be repeated.

The monitoring apparatus 1 according to the first embodiment determines the operating states of the server apparatuses 2 that are accessed from the terminal apparatuses 3. The monitoring apparatus 1 according to the second embodiment determines operating states of the terminal apparatuses 3.

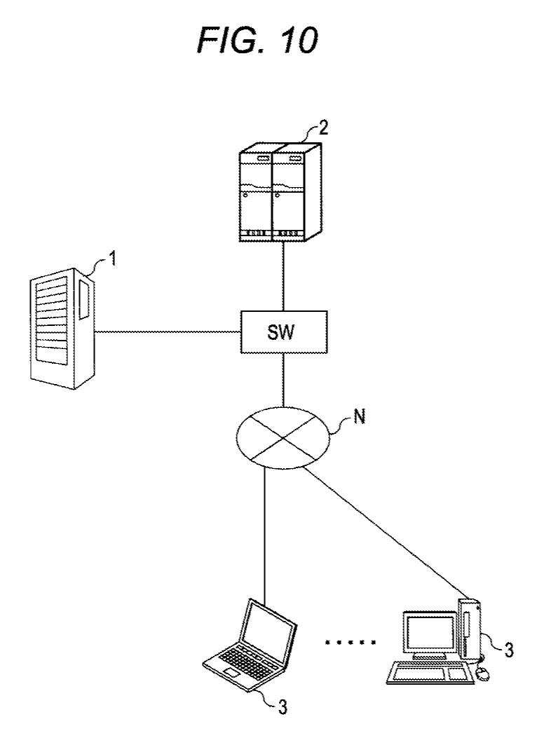

FIG. 10 illustrates the configuration of a monitoring system according to a second embodiment. In the monitoring system according to the second embodiment, the monitoring apparatus 1 and one server apparatus 2 are connected to a network N through a switching device SW, such as a router. Accordingly, the monitoring apparatus 1 and the server apparatus 2 can perform communication between the plurality of terminal apparatuses 3, through the switching device SW and the network N.

Further, in the monitoring system according to the second embodiment, the server apparatus 2 is a mail server. The monitoring apparatus 1 according to the second embodiment monitors packets, such as a pop3 (Post Office Protocol), an IMAP (Internet Message Access Protocol), and an SMTP (Simple Mail Transfer Protocol), which are transmitted from the monitored terminal apparatuses 3 to the server apparatus 2. However, the present invention is not limited to this configuration, and the monitoring apparatus 1 may monitor packets of other applications, such as an HTTP, a DHCP, and a DNS (Domain Name System).

The monitoring apparatus 1 according to the second embodiment acquires the packets, which are regularly transmitted and received between the terminal apparatuses 3 and the server apparatus 2, through the switching device SW. The monitoring apparatus 1 determines an operating state of each of the terminal apparatuses 3 based on the acquired packets. That is, the monitoring apparatus 1 calculates the amounts of traffic in the terminal apparatuses 3 based on the packets that are transmitted from the terminal apparatuses 3, and determines the operating states of the terminal apparatuses 3 based on the calculated amounts of traffic.

The monitoring apparatus 1 according to the second embodiment sets the terminal apparatuses 3 as the monitored apparatuses, and determines whether each of the terminal apparatuses 3 is in a power-on state or a power-off state. When each of the terminal apparatuses 3 is in the power-on state, the monitoring apparatus 1 determines whether each of the terminal apparatuses 3 is being used. Further, the monitoring apparatus 1 according to the second embodiment has the same configuration as the configuration illustrated in FIG. 2. However, instead of the response packet history DB 13b, a packet history DB 13b is stored in an HDD 13, and the setting information DB 13d is not needed. Further, the packet history DB 13b has the same configuration as the response packet history DB 13b according to the first embodiment.

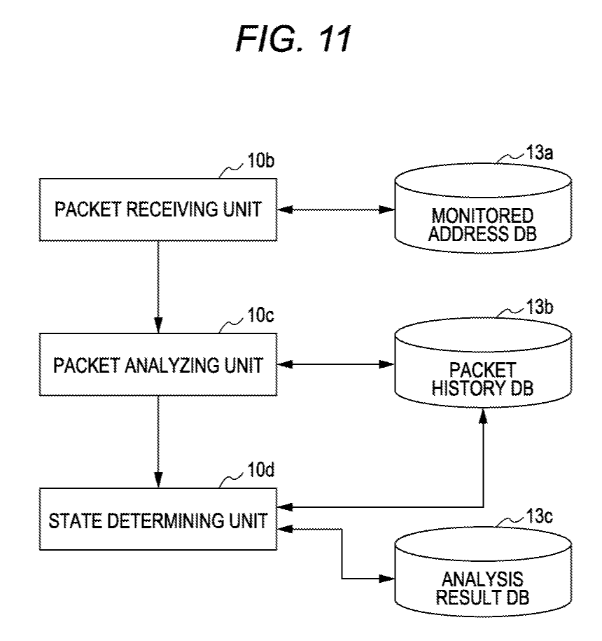

Hereinafter, in the monitoring apparatus 1 according to the second embodiment, the control unit 10 reads out the control program, which is stored in the ROM 11 or the HDD 13, in the RAM 12 and executes the control program, thereby realizing the functions of the monitoring apparatus 1, which will be described in detail below. FIG. 11 illustrates the functional configuration of the monitoring apparatus 1 according to a second embodiment.

In the monitoring apparatus 1 according to the second embodiment, the control unit 10 executes the control program that is stored in the ROM 11 or the HDD 13, thereby realizing individual functions of a packet receiving unit 10b, a packet analyzing unit 10c, and a state determining unit 10d.

The packet receiving unit 10b executes the same process as the response packet receiving unit 10b according to the first embodiment. The packet receiving unit 10b according to the second embodiment acquires (captures) a packet that is transmitted and received between the server apparatus 2 and the terminal apparatuses 3 through the switching device SW. The packet receiving unit 10b determines whether the acquired packet is a packet having a mail protocol. In this case, when it is determined that the acquired packet is not the packet having the mail protocol, the packet receiving unit 10b discards the acquired packet.

When it is determined that the acquired packet is the packet having the mail protocol, the packet receiving unit 10b extracts an IP address of a transmission source apparatus from the acquired packet, and determines whether the extracted IP address is stored in the monitored address DB 13a. Thereby, the packet receiving unit 10b may determine whether the extracted IP address is an IP address of the monitored terminal apparatus 3. When it is determined that the extracted IP address is not stored in the monitored address DB 13a, the packet receiving unit 10b discards the acquired packet.

When it is determined that the extracted IP address is stored in the monitored address DB 13a, the packet receiving unit 10b transmits the acquired packet to the packet analyzing unit 10c. Thereby, the monitoring apparatus 1 may set the terminal apparatuses 3 having the IP addresses, which are stored in the monitored address DB 13a, as the monitored address, and extract only the packets that are transmitted from the monitored terminal apparatuses 3.

The packet analyzing unit 10c executes the same process as the response packet analyzing unit 10c according to the first embodiment. That is, when the packet analyzing unit (specifying unit) 10c acquires a packet from the packet receiving unit 10b, the packet analyzing unit 10c acquires and extracts an IP address and an IP-ID (ID field of an IP header) of the terminal apparatus 3 to be a transmission source, from the acquired packet. The packet analyzing unit 10c associates the extracted IP address and IP-ID and a date and time (reception date and time) when the packet is received and stores the association result as history information in the packet history DB 13b.

Further, the packet analyzing unit 10c determines whether history information including the same IP address as the IP address of the history information stored in the packet history DB 13b is previously stored in the response packet history DB 13b. When the history information including the same IP address is not yet stored in the packet history DB 13b, the packet analyzing unit 10c does not execute a calculating process of the amount of traffic since the previous packet in the history information stored in the packet history DB 13b, and stores no information in the column of the amount of traffic since the previous packet in the history information.

Meanwhile, when it is determined that the history information including the same IP address is previously stored in the packet history DB 13b, the packet analyzing unit 10c determines whether a difference between a reception date and time of the history information, which is stored in the packet history DB 13b, and a reception date and time of the history information including the same IP address is the same as a specific time. That is, the packet analyzing unit (determining unit) 10c determines whether the two packets output from the same server apparatus 2 are received at the specific time interval.

When the difference between the reception dates and times is not the same as the specific time, the packet that the packet receiving unit 10b has received is set as the first packet of the monitoring process with respect to the terminal apparatus 3 having the IP address. Accordingly, in this case, the packet analyzing unit 10c does not execute a calculating process of the amount of traffic since the previous packet in the history information stored in the packet history DB 13b, and stores no information in the column of the amount of traffic since the previous packet in the history information.

Meanwhile, when the difference between the reception dates and times is the same as the specific time, the packet analyzing unit 10c calculates a difference (communication amount) between the IP-ID of the history information, which is stored in the packet history DB 13b, and the IP-ID of the history information including the same IP address. The packet analyzing unit 10c stores the calculated difference as the amount of traffic since the previous packet in the history information that is stored in the packet history DB 13b.

The state determining unit 10d according to the second embodiment executes the same process as the state determining unit 10d according to the first embodiment. That is, the state determining unit 10d determines an operating state of each of the terminal apparatuses 3, based on the history information that is stored in the packet history DB 13b. Specifically, the state determining unit 10d determines that the terminal apparatus 3 is in an operating state (power-on state) but is not being used when the amount of traffic since the previous packet, which is included in the history information, is smaller than the specified value (for example, 10). At this time, the state determining unit 10d associates the IP address of the terminal apparatus 3 and the determination result “power-on/out-of-use” with each other and stores the association result in the analysis result DB 13c.

Further, when the amount of traffic since the previous packet, which is included in the history information, is the specified value (for example, 10) or more, the state determining unit 10d determines whether the amount of traffic is the amount of traffic based on the specific packet that is regularly transmitted. In this case, when it is determined that the amount of traffic is the amount of traffic based on the regular communication, the state determining unit 10d determines that the terminal apparatus 3 is in an operating state but is not being used. At this time, the state determining unit 10d associates the IP address of the terminal apparatus 3 and the determination result “power-on/out-of-use” with each other and stores the association result in the analysis result DB 13c. Thereby, the terminal apparatuses 3 that perform only the regular communication and are not actually being used may be properly determined as “out-of-use”.

Meanwhile, when it is determined that the amount of traffic is not the amount of traffic based on the regular communication, the state determining unit 10d determines that the terminal apparatus 3 is in an operating state and is being used. At this time, the state determining unit 10d associates the IP address of the terminal apparatus 3 and the determination result “power-on/in-use” with each other and stores the association result in the analysis result DB 13c. Thereby, the terminal apparatuses 2 that are actually being used may be properly determined as “in-use”.

Further, since the monitoring apparatus 1 according to the second embodiment does not transmit the measurement packets to the terminal apparatuses 3, the state determining unit 10d according to the second embodiment does not execute the transmission interval setting process that is executed by the state determining unit 10d according to the first embodiment.

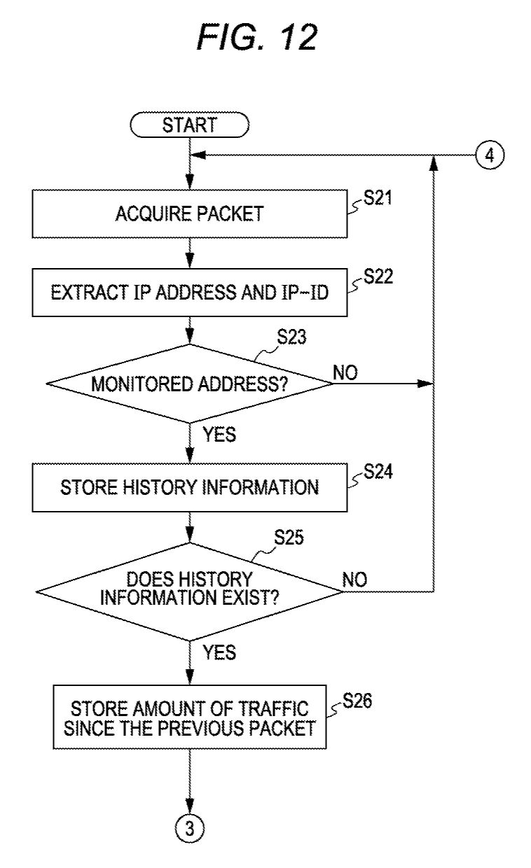

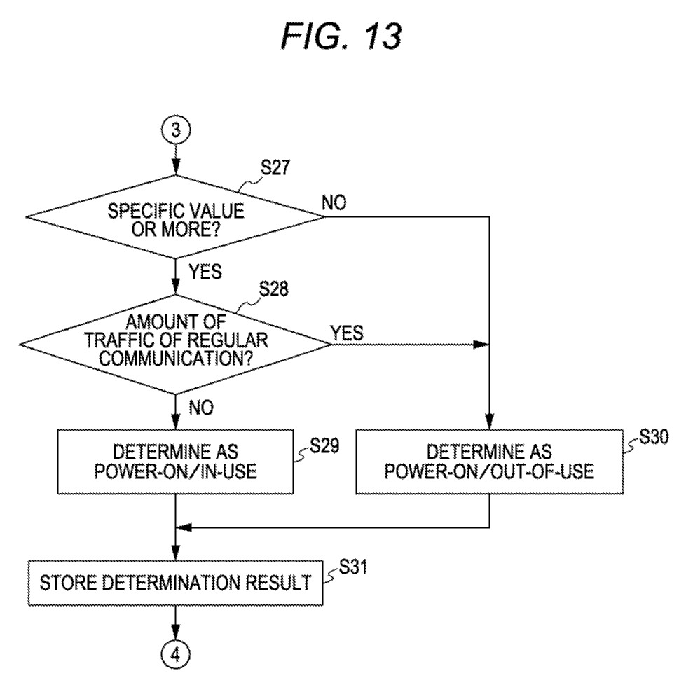

FIGS. 12 and 13 are flowcharts illustrating a monitoring process according to a second embodiment. The following process is executed by the control unit 10 in accordance with the control program that is stored in the ROM 11 or the HDD 13 of the monitoring apparatus 1.

The control unit 10 of the monitoring apparatus 1 acquires a packet that is transmitted and received between the server apparatus 2 and the terminal apparatuses 3 through the switching device SW (S21). The control unit 10 extracts an IP address and an IP-ID of the server apparatus 2 of a transmission source, from the acquired packet (S22). The control unit 10 determines whether the terminal apparatus 3 having the extracted IP address is the monitored terminal apparatus 3 based on whether the acquired packet is a packet having a mail protocol. The extracted IP address is stored in the monitored address DB 13a (S23).

When it is determined that the acquired packet is not the packet having the mail protocol or the acquired packet is the packet having the mail protocol but the terminal apparatus 3 having the extracted IP address is not the monitored terminal apparatus 3 (S23: NO), the control unit 10 returns to Step S21. Meanwhile, when it is determined that the acquired packet is the packet having the mail protocol and the terminal apparatus 3 having the extracted IP address is the monitored terminal apparatus 3 (S23: YES), the control unit 10 associates the extracted IP address and IP-ID and a date and time when the packet is received and stores the association result as history information in the packet history DB 13b (S24).

The control unit 10 determines whether there is history information that includes a reception date and time that goes back to the past by the specific time in the previous history information that includes the same IP address as the IP address of the history information stored in the packet history DB 13b (S25). When it is determined that the history information does not exist (S25: NO), the control unit 10 returns to Step S21.

Meanwhile, when it is determined that the history information exists (S25: YES), the control unit 10 calculates a difference between the IP-ID of the previous history information and the IP-ID of the history information stored now in the packet history DB 13b in Step S24, and stores the difference as the amount of traffic since the previous packet in the history information stored in the packet history DB 13b in Step S24 in the packet history DB 13b (S26).

The control unit 10 determines whether the amount of traffic stored in Step S26 is the specified value or more (S27). When it is determined that the amount of traffic is the specified value or more (S27: YES), the control unit 10 determines whether the amount of traffic in the history information of the packet received from the terminal apparatus 3 is the amount of traffic based on the regular communication (S28).

When it is determined that the amount of traffic is not the amount of the traffic based on the regular communication (S28: NO), the control unit 10 determines that the terminal apparatus 3 of the transmission source of the packet acquired in Step S21 is in a power-on/in-use state (S29). The control unit 10 stores the determination result in the analysis result DB 13c (S31) and returns to Step S21.

When it is determined that the amount of traffic is smaller than the specified value (S27: NO) or the amount of traffic based on the regular communication (S28: YES), the control unit 10 determines that the terminal apparatus 3 of the transmission source of the packet acquired in Step S21 is in a power-on/out-of-use state (S30). The control unit 10 stores the determination result in the analysis result DB 13c (S31) and returns to Step S21.

The monitoring apparatus 1 according to the second embodiment may execute the above-described process whenever the packet is acquired, thereby precisely determining whether each of the terminal apparatuses 3, which transmit the packet to the server apparatus 2, is actually being used. Accordingly, it is possible to detect the terminal apparatuses 3 that perform only communication for regular automatic updating of a web or electronic mail and are not actually being used, regardless of state of supply of power. Further, it is possible to reduce wasteful power consumption by stopping supply of power to the terminal apparatuses 3.

The monitoring apparatus 1 according to the second embodiment sets the terminal apparatuses 3 as the monitored apparatus and monitors the operating states of the terminal apparatuses 3 to be the transmission sources based on the packets that are transmitted from the terminal apparatuses 3 to the server apparatus 2. However, the present invention is not limited to the above configuration, and the monitoring apparatus 1 may set a transmission source apparatus and a transmission destination apparatus of each packet that may be acquired through the switching device SW as the monitored apparatus.

The monitoring apparatus 1 according to the second embodiment is configured to be connected to the switching device SW provided between the server apparatus 2 and the terminal apparatuses 3, but the present invention is not limited to the above configuration. Similar to the monitoring apparatus 1 according to the first embodiment, the monitoring apparatus 1 may be directly connected to the network N, and capture the packets transmitted and received between the server apparatus 2 and the terminal apparatuses 3 on the network N. Further, when a transmission source apparatus or a transmission destination apparatus of the captured packet is configured to be added as the monitored apparatus, if the above process is executed, the apparatus that is excluded from the monitored apparatus in the monitoring system according to the first embodiment may be set as the monitored apparatus.

### Third Embodiment

Since a monitoring system according to a third embodiment may be realized by the same configuration as the monitoring system according to the first embodiment, the same constituent elements will be denoted by the same reference numerals and the description will not be repeated.

The monitoring apparatus 1 according to the first embodiment calculates the amount of traffic in each of the server apparatuses 2, based on the IP-ID of the response packet that is returned with respect to the measurement packet transmitted to each of the server apparatuses 2. This reason is as follows. When each apparatus transmits the IP packet, since the value of the ID field of the IP header is incremented by one, it is possible to recognize the number of transmitted packets while the apparatus transmits the two packets, by comparing the two IP-ID values of the two packets transmitted from the same apparatus.

However, since an apparatus where Linux is installed is not assigned with an IP-ID in the above method, in the method that is disclosed in this invention, the amount of traffic cannot be detected. That is, in the case where the monitoring apparatus 1 according to the first embodiment executes a monitoring process with respect to an apparatus where a value of an ID field of an IP header is not incremented by one, the “amount of traffic since the previous packet” that is stored in the response packet history DB 13b when the response packet is received does not become a proper value.

For example, in the case of an apparatus where a value of an IP-ID assigned to a response packet returned to a measurement packet becomes a fixed value, the “amount of traffic since the previous packet” that is stored in the response packet history DB 13b when the response packet is received always becomes 0. Accordingly, this apparatus is erroneously determined as a power-on/out-of-use state, because the amount of traffic since the previous packet in the history information is 0, regardless of whether the apparatus is being used or not.

Accordingly, the monitoring apparatus 1 according to the third embodiment includes the configuration where it is confirmed regularly, for example once a day, whether an apparatus having the possibility to cause an erroneous determination is included in the monitored apparatus, and excludes the apparatus having the possibility of causing the erroneous determination from the monitored apparatus. Specifically, the control unit 10 detects an IP address where the amount of traffic since the previous packet is always 0, for example, for history information of the same IP address, with respect to the history information that is stored in the response packet history DB 13b. Further, the server apparatuses 2 having the IP addresses where the amount of traffic since the previous packet is always 0 are terminals that need to confirm whether or not they are to be excluded from the monitored apparatus.

Hereinafter, the description is given on the assumption that the server apparatus 2 is a web server. When there is the server apparatus 2 that needs to confirm whether or not to be excluded from the monitored apparatus, the measurement packet is transmitted to the server apparatus 2. The control unit 10 determines whether the response packet from the server apparatus 2 is received in the specific time-out period. When it is determined that the response packet is received in the specific time-out period, the control unit 10 transmits an HTTP packet for a web access to the server apparatus 2 that is a web server. After receiving an HTTP packet corresponding to the HTTP packet from the server apparatus 2, the control unit 10 retransmits a measurement packet to the server apparatus 2.

The control unit 10 determines again whether a response packet from the server apparatus 2 is received in the specific time-out period. When it is determined that the response packet is received in the specific time-out period, the control unit 10 calculates a difference between IP-IDs of the acquired two response packets. Here, in the case of the configuration where a value of the IP-ID is incremented by one when the server apparatus 2 transmits the packet, the calculated amount of traffic becomes 2 or more. This is because the server apparatus 2 transmits at least two response packets corresponding to the two measurement packets received from the monitoring apparatus 1.

However, in the case where the calculated amount of traffic is smaller than 2, for example, in the case the calculated amount of traffic is 0, since the server apparatus 2 cannot be monitored by the monitoring apparatus 1, the server apparatus 2 is excluded from the monitored apparatus. The control unit 10 deletes the IP address of the server apparatus 2 from the monitored address DB 13a. When the calculated amount of traffic is 2 or more, since the server apparatus 2 is properly operated and may be monitored by the monitoring apparatus 1, the server apparatus 2 is not excluded from the monitored apparatus. Further, in the case where the response packet is not received in the specific time-out period, since the server apparatus 2 is in a power-off state, the server apparatus 2 is not excluded from the monitored apparatus.

Since the server apparatus 2 returns packets corresponding to the received packets in reception order of the individual packets, the monitoring apparatus 1 is not limited to the configuration where an HTTP packet is transmitted after reception of the first response packet is confirmed, and may transmit the HTTP packet immediately after transmitting the first measurement packet. In the same way, the monitoring apparatus 1 may transmit the second measurement packet before confirming reception of the HTTP packet corresponding to the transmitted HTTP packet.

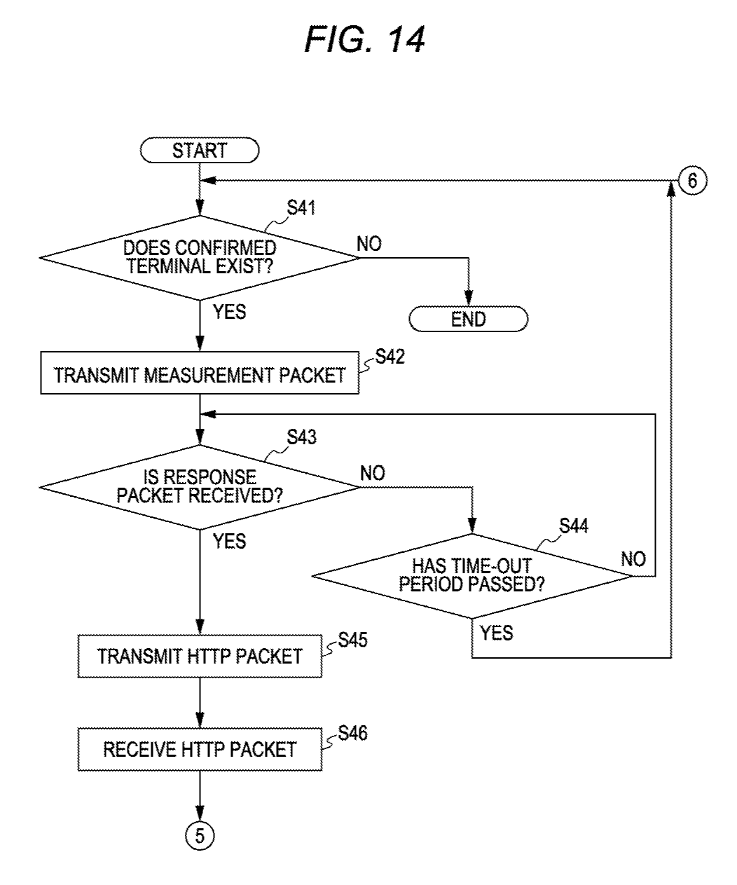

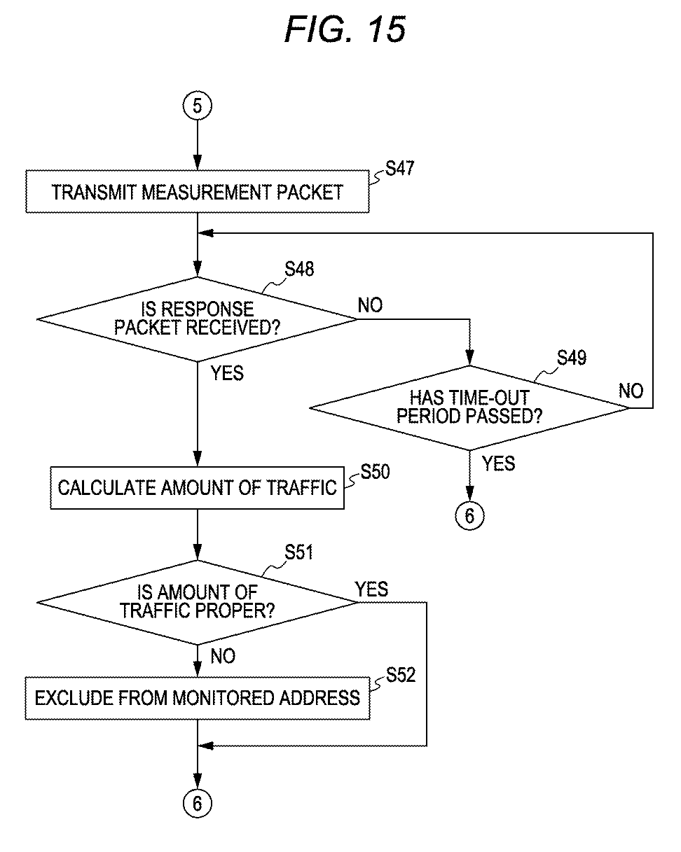

FIGS. 14 and 15 are flowcharts illustrating a monitored apparatus confirming process according to a third embodiment. The following process is executed by the control unit 10 in accordance with the control program that is stored in the ROM 11 or the HDD 13 of the monitoring apparatus 1.

The control unit 10 of the monitoring apparatus 1 determines whether there is a terminal that needs to confirm whether or not to be excluded from the monitored apparatus, based on whether there is history information that has the same IP address with respect to the history information stored in the response packet history DB 13b and has the amount of traffic since the previous packet to be always 0 (S41). When it is determined that there is no terminal that needs to confirm whether or not to be excluded from the monitored apparatus (S41: NO), the control unit 10 completes the monitored apparatus confirming process.

When it is determined that there is a terminal that needs to confirm whether or not to be excluded from the monitored apparatus (S41: YES), the control unit 10 transmits the first measurement packet to the server apparatus 2 (S42). The control unit 10 determines whether the first response packet is received from the server apparatus 2 that has transmitted the first measurement packet (S43). When it is determined that the first response packet is not received (S43: NO), the control unit 10 determines whether the specific time-out period has passed (S44).

When it is determined that the specific time-out period has not passed (S44: NO), the control unit 10 returns the procedure to the process of Step S43. When it is determined that the time-out period has passed (S44: YES), the control unit 10 determines that the server apparatus 2 is in a power-off state and returns to Step S41.

When it is determined that the first response packet is received (S43: YES), the control unit 10 transmits the HTTP packet to the server apparatus 2 (S45). When the HTTP packet returned from the server apparatus 2 is received with respect to the transmitted HTTP packet (S46), the control unit 10 transmits the second measurement packet to the server apparatus 2 (S47). The control unit 10 determines whether the second response packet is received from the server apparatus 2 that has transmitted the second measurement packet (S48). When it is determined that the second response packet is not received (S48: NO), the control unit 10 determines whether the specific time-out period has passed (S49).

When it is determined that the time-out period has not passed (S49: NO), the control unit 10 returns to Step S48. When it is determined that the time-out period passes (S49: YES), the control unit 10 determines that the server apparatus 2 is in a power-off state and returns to Step S41.

When it is determined that the second response packet is received (S48: YES), the control unit 10 calculates a difference (traffic amount) between the IP-ID of the first response packet received in Step S43 and the IP-ID of the second response packet received in Step S48 (S50).

The control unit 10 determines whether the calculated amount of traffic is proper (S51). Specifically, the control unit 10 determines whether the calculated amount of traffic is 2 or more. When it is determined that the calculated amount of traffic is not proper (smaller than 2) (S51: NO), the control unit 10 excludes the server apparatus 2 from the monitored address DB13a (S52). Specifically, the control unit 10 deletes the IP address of the server apparatus 2 from the monitored address DB 13a. When it is determined that the calculated amount of traffic is proper (2 or more) (S51: YES), the control unit 10 skips the process of Step S52 and does not exclude the server apparatus 2 from the monitored address DB13a.

The control unit 10 returns the procedure to the process of Step S41, and executes the above process with respect to all of the terminals that are to be confirmed whether or not to be excluded from the monitored apparatus. Thereby, from the terminals that are to be confirmed whether or not to be excluded from the monitored apparatus, it is possible to specify the terminals to be excluded from the monitored apparatus. As a result, the terminals that cannot be properly determined by the monitoring apparatus 1 according to the first embodiment may be excluded from the monitored apparatus, and an erroneous determination of an operating state of each terminal may be prevented.

In the monitoring apparatus that is disclosed in this application, without executing a setting process for each monitored apparatus, even in a situation where a plurality of monitored apparatuses exist, all of the apparatuses may be monitored by one monitoring apparatus. Further, with respect to each monitored apparatus, it is determined whether power is supplied. In addition, when the power is supplied to the monitored apparatus, it may be determined whether the monitored apparatus is actually being used by the user.

In this application, if the computer program where the above-described operation of the monitoring apparatus is defined is read out by the computer and executed, the above-described monitoring apparatus may be realized by the computer.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A monitoring apparatus which monitors an operating state of a monitored apparatus, the monitoring apparatus comprising:
a signal acquiring unit that acquires signals output from the monitored apparatus at any time;
a communication amount acquiring unit that acquires a communication amount by which the monitored apparatus performs communication in a specific time based on information included in the plurality of signals that the signal acquiring unit acquires at a specific time interval; and
a state determining unit that determines the operating state of the monitored apparatus based on the communication amount acquired by the communication amount acquiring unit.

2. The monitoring apparatus according to claim 1, further comprising:
a signal output unit that repetitively outputs a specific signal to the monitored apparatus at the specific time interval; and
a determining unit that determines whether the signal acquiring unit acquires the plurality of signals at the specific time interval,
wherein the signal acquiring unit acquires a signal that is returned with respect to the specific signal output by the signal output unit,
when the determining unit determines that the signal acquiring unit acquires the plurality of signals, the communication amount acquiring unit acquires the communication amount of the monitored apparatus in the specific time based on the information that is included in the plurality of signals, and
when the determining unit determines that the signal acquiring unit does not acquire the plurality of signals, the state determining unit determines that the monitored apparatus is in a non-operating state, and when the determining unit determines that the signal acquiring unit acquires the plurality of signals, the state determining unit determines that the monitored apparatus is in an operating state, and determines whether the monitored apparatus determined to be in the operating state is being used based on the communication amount acquired by the communication amount acquiring unit.

3. The monitoring apparatus according to claim 2,
wherein the signal output unit outputs the specific signal to a plurality of monitored apparatuses that are set in advance, and
when the signal that is returned with respect to the specific signal output by the signal output unit is acquired by the signal acquiring unit, a transmission source apparatus of the signal that is acquired by the signal acquiring unit is set as the monitored apparatus.

4. The monitoring apparatus according to claim 2, further comprising:
a history information storage unit that stores history information related to the signal acquired by the signal acquiring unit; and
a setting unit that sets the specific time which is an output interval at which the signal output unit outputs the specific signal based on the history information that is stored in the history information storage unit.

5. The monitoring apparatus according to claim 1, further comprising:
a specifying unit that specifies a transmission source apparatus of the signal, based on the signal acquired by the signal acquiring unit; and
a determining unit that determines whether the plurality of signals that the signal acquiring unit acquires at the specific time intervals are signals output from the same apparatus specified by the specifying unit,
wherein, the signal acquiring unit acquires a signal that is transmitted and received between external apparatuses,
when the determining unit determines that the plurality of signals are signals output from the same apparatus, the communication amount acquiring unit acquires the communication amount of the monitored apparatus in the specific time based on the information that is included in the plurality of signals, and
the state determining unit determines whether the monitored apparatus is being used based on the communication amount acquired by the communication amount acquiring unit.

6. The monitoring apparatus according to claim 5,
wherein the specifying unit specifies a transmission source apparatus and a transmission destination apparatus of the signal based on the signal that is acquired by the signal acquiring unit, and
the transmission source apparatus and the transmission destination apparatus that are specified by the specifying unit are set as the monitored apparatuses.

7. The monitoring apparatus according to claim 1,
wherein the signals that are output from the monitored apparatus include order information indicating an output order from the monitored apparatus, and
the communication amount acquiring unit calculates the communication amount by which the monitored apparatus performs communication in the specific time based on the order information included in each of the plurality of signals acquired by the signal acquiring unit.

8. The monitoring apparatus according to claim 1,
wherein the state determining unit determines that the monitored apparatus is being used when the communication amount acquired by the communication amount acquiring unit is a specific amount or more.

9. The monitoring apparatus according to claim 1,
wherein, when the communication amount acquired by the communication amount acquiring unit is the specific amount or more, the state determining unit analyzes the time-ordered communication amount acquired previously by the communication amount acquiring unit and determines whether a temporal periodicity exists, and
when it is determined that the temporal periodicity does not exist, the state determining unit determines that the monitored apparatus is being used.

10. The monitoring apparatus according to claim 1, further comprising:
a signal transmitting unit that transmits the specific signal to the monitored apparatus in the specific time until the signal acquiring unit acquires a next signal after acquiring one signal;
a communication amount determining unit that determines whether the communication amount acquired by the communication amount acquiring unit is a proper value based on the plurality of signals that are acquired by the signal acquiring unit; and
an excluding unit that excludes the monitored apparatus when the communication amount determining unit determines that the communication amount acquired by the communication amount acquiring unit is not the proper value.

11. A monitoring method which is used in a computer for a monitoring apparatus monitoring an operating state of a monitored apparatus, the monitoring method comprising:
acquiring, by the monitoring apparatus, signals output from the monitored apparatus at any time;
acquiring, by the monitoring apparatus, a communication amount by which the monitored apparatus performs communication in a specific time based on information included in the plurality of signals that are acquired at the specific time intervals; and
determining, by the monitoring apparatus, the operating state of the monitored apparatus based on the acquired communication amount.

12. A computer readable storage medium storing a monitoring program for allowing a computer to monitor an operating state of a monitored apparatus, the monitoring program causing a computer to function as:
calculating a communication amount by which the monitored apparatus performs communication in a specific time based on information included in a plurality of signals that are output from the monitored apparatus at a specific time interval; and
determining the operating state of the monitored apparatus based on the calculated communication amount.
